(19) United States
(12) Patent Application Publication
(10) Pub. No.: US 2007/0080944 A1
(43) Pub. Date: Apr. 12, 2007

(54) Mouse with disengageable scroll function

(76) Inventor: Benjamin M. Parees, Durham, NC (US)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/246,424

(22) Filed: Oct. 7, 2005

(51) Int. Cl. G09G 5/08

(52) U.S. Cl. 345/163

(57) ABSTRACT

The present invention is a mouse having a clickable scrolling wheel that includes a locking capability that is activated only when a user performs a clicking operation on the scroll wheel. In one embodiment, when the scroll wheel is depressed downward during a clicking operation, a slat element connected to the scroll wheel engages a non-movable slot, and the scroll wheel is prohibited from scrolling. When the user releases the scroll wheel, the slat element disengages from the slot and the scrolling operation of the scroll wheel is again available. In an alternative embodiment, depressing the scroll wheel during a clicking operation temporarily breaks an electrical connection associated with the scrolling operation of the scroll wheel, so that movement of the scroll wheel about its axis while depressed has no control functionality.

### BACKGROUND OF THE INVENTION

1. Field of the Invention

The present invention generally relates to computer systems and, more particularly, to a pointing device, commonly referred to as a mouse, which is used to control a visual pointer on a display of the computer system.

2. Description of the Related Art

The computer mouse is well known and consists of a shell and a sensing element on the underside of the shell, and an output means for interface with computer. The sensing element typically comprises either a spherical ball or an optical element on the underside of the mouse. As the mouse slides across a surface, the sensing element senses the motion and data corresponding to the sensed motion is sent to the computer via the interface. The movement of the mouse on the surface corresponds with the movement of a cursor or other indicator on the computer display. A mouse also includes selection actuators such as buttons on the top surface of the shell which can be activated by pressing them. When activated, the selection actuators send a signal to the computer to perform a function. Activation of each selection actuator can result in a different function being performed.

More recently, the use of mice with a scroll wheel, for scrolling an image on a display, has become commonplace. The scroll wheel is mounted so that a portion of the circumference thereof is exposed through the shell of the mouse. When a user rotates a peripheral edge portion of the scroll wheel in one direction, the images on the display are scrolled upward or downward, depending on the direction in which the wheel is rotated, and by an amount depending on the amount by which the wheel is rotated. Frequently, the wheel is “clickable” so that the action of pressing down on the scroll wheel will send a signal to the computer to perform a function.

A problem exists due to the dual action (scrolling and clicking) of the clickable scroll wheel. Since it is both scrollable and clickable, it is common for a user to accidentally scroll the scroll wheel while trying to click it. The user must perform a perfectly straight downward click or risk scrolling the cursor at the same time. Existing solutions include providing means to make it more difficult to rotate the scroll wheel, thus reducing the likelihood that the wheel will turn while it is being clicked. This, however, increases the strain and fatigue of the user. Such additional strain and fatigue can increase the likelihood of repetitive strain injury for the user. It would, therefore, be desirable to devise a mouse design that minimizes and/or disengages the scrolling function of the scroll wheel when performing a click action using the scroll wheel.

### SUMMARY OF THE INVENTION

The present invention is a mouse having a clickable scrolling wheel that includes a disengagement capability that is activated only when a user performs a clicking operation on the scroll wheel. In one embodiment, when the scroll wheel is depressed downward during a clicking operation, a slat element connected to the scroll wheel engages a non-movable slot, and the scroll wheel is physically prohibited from rotating. When the user releases the scroll wheel, the slat element disengages from the slot and the scrolling operation of the scroll wheel is again available. In an alternative embodiment, depressing the scroll wheel during a clicking operation temporarily breaks an electrical connection associated with the scrolling operation of the scroll wheel, so that movement of the scroll wheel about its axis while depressed has no control functionality.

### BRIEF DESCRIPTION OF THE DRAWINGS

FIGS. 1A and 1B illustrate said and front views, respectively, of an embodiment of the present invention in a “free rotation” position;

FIGS. 2A and 2B illustrate side and front views, respectively, of embodiment of FIGS. 1A and 1B with the scroll wheel depressed and in a disengaged position; and

FIG. 3 is a flowchart illustrating an example of the basic steps of a method in accordance with the present invention.

### DETAILED DESCRIPTION OF THE PREFERRED EMBODIMENTS

The overall structure of a mouse with a scroll wheel is well known and the details of the structure of prior art mice are not discussed further herein. Numerous examples of mice and mice with wheel elements are in the prior art; see, for example, U.S. Pat. No. 6,697,050 and U.S. Pat. No. 6,727,889.

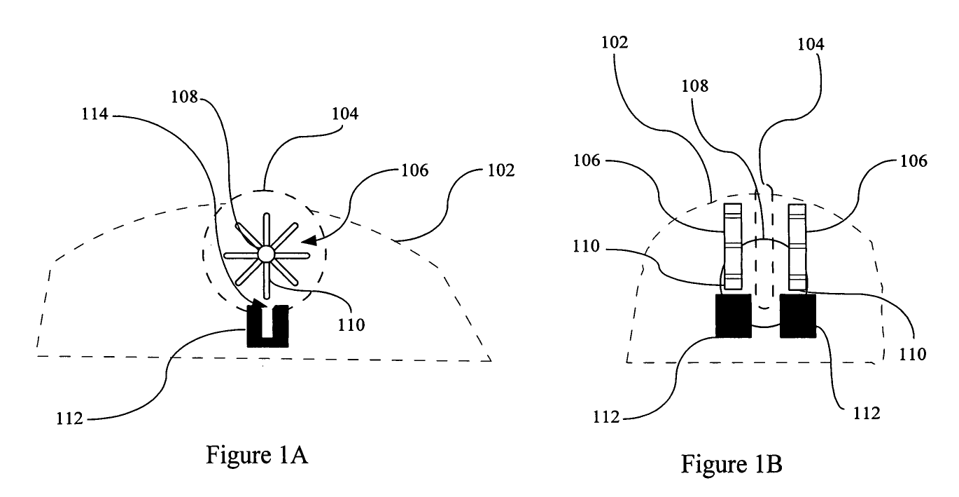

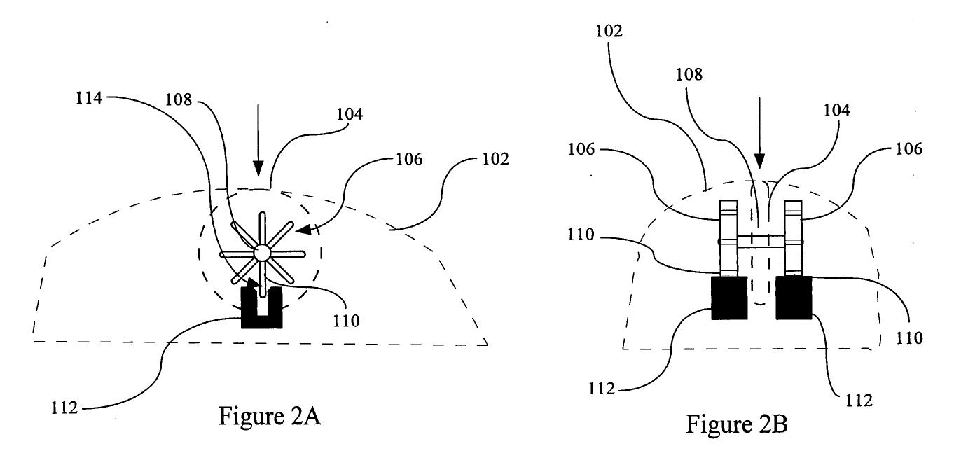

The present invention is described below with reference to FIGS. 1 and 2. FIGS. 1A and 1B illustrate said and front views, respectively, of the present invention in the “free rotation” position. A mouse shell 102 houses the various components required for the mouse to function as a pointing device. For simplicity, these elements, which are well known, are not shown. They scroll wheel 104 extends through a slot in the shell 102 in a well known manner, giving the user the ability to scroll and/or depress scroll wheel 104 to control the various functions provided thereby. As is well known, scroll wheels typically include detents or stop-points that define the stopped position of the scroll wheel at any given time. These detents or stop-points can be actual, e.g., click-stops, or virtual, e.g., smooth stops.

In accordance with the present invention, the scroll wheel mechanism includes a slat element 106 mounted on an axle 108 that extends through scroll wheel 104. Since scroll wheel 104 already has an axle on which it rotates, the axle 108 can simply be an extension of the same axle. One of the slats is always in the “six o'clock” position, and this slat is referred to as the “downward-pointing slat”. In FIGS. 1A and 1B, the downward-pointing slat is slat 110. The multiple slats of slat element 106 preferably correspond to the detents/stop-points of the scroll wheel 104. In the example of FIG. 1, eight slats are shown; however, it is understood that there can be a larger or smaller number of slats, depending upon the number of detents/stop-points of the scroll wheel.

A pair of fixed (non-moving) slotted elements 112 is situated beneath the slat element 106 as shown. A slot 114 faces upwards lining up with downward pointing slat 110 of the slat element 106. Preferably, the spacing tolerance between the downward slat 110 and the slot 114 will be such that the slats can rotate past the slot 114 freely, but just barely. When the user begins to depress the scroll wheel downward, the axle and slat element 106 move with it. The downward pointing slat 110 immediately engages in the slot 114. Once so engaged, the scroll wheel is unable to rotate, and thus the scrolling function is disabled until the wheel is released and the axle returns to the resting position.

FIGS. 2A and 2B illustrate side and front views, respectively, of the present invention with the scroll wheel depressed and the downward-pointing slat 110 in the engaged position. As can be seen, the downward slat 110 is engaged with the slot 114. In this engaged position, the scroll wheel 104 cannot rotate about axle 108. Due to the spring-action of scroll wheel 104, the scroll wheel will move back to the upward position of FIGS. 1A and 1B when the user releases the downward pressure on the scroll wheel 104. This disengages the downward pointing slats 110 from the slot 114, thereby enabling the scroll wheel 104 to again rotate about the axle 108.

This locking mechanism prevents the scroll wheel from rotating while it is being depressed. This allows the user to click the wheel without having to always perform a perfectly straight downward motion. Since the scroll wheel operates freely when it is not being depressed, there is no additional fatigue caused as is caused by the prior art.

In an alternative embodiment, the functional operation of the scroll wheel when in the depressed position can be electrically, rather than mechanically, disengaged. For example, a simple switching mechanism can be included whereby upon depressing of the scroll wheel to perform a click operation, switch contacts are broken which sever the electrical connection between the rotational structure of the scroll wheel and the processor that is receiving the control signals from the mouse. Thus, when the scroll wheel is depressed, rotational movement of the scroll wheel will not affect the control operations being performed by the mouse, since the processor will receive no electrical indication that the scroll wheel is actually moving. The break in the electrical connection suspends the scrolling function of the scroll wheel. Once the user releases the scroll wheel from the clicked position, the electrical contacts are reconnected and the scrolling function of the scroll wheel resumes.

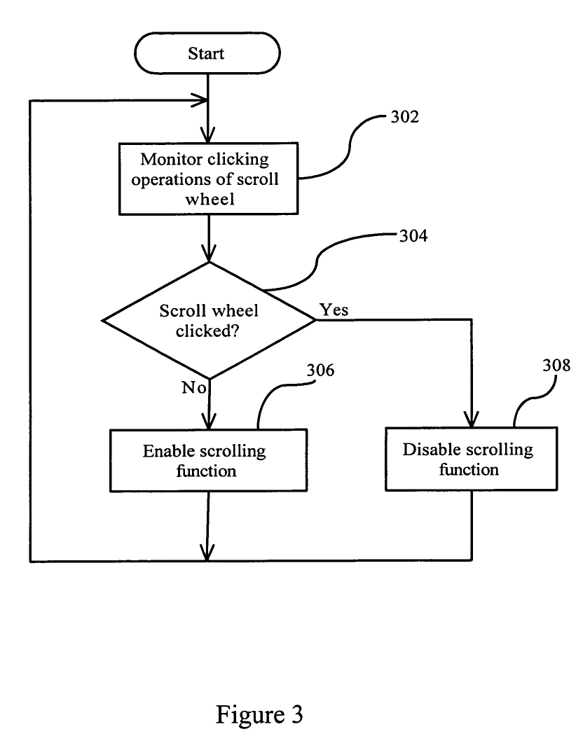

FIG. 3 is a flowchart illustrating the basic steps of a method in accordance with the present invention. Referring to FIG. 3, at step 302 the clicking operations of the scroll wheel of the mouse are monitored. If, at step 304, it is determined that the scroll wheel is not currently clicked, that the scrolling function is enabled (step 306) in the process reverts back to step 302 to continue monitoring of the clicking operations of the scroll wheel. If, at step 304, it is determined that the scroll wheel is currently clicked, then the scrolling function is disabled (step 308) in the process reverts back to step 302 to continue monitoring the clicking operations of the scroll wheel. In this manner, whenever the scroll wheel is clicked, the scrolling function is disabled, and whenever the scroll wheel is not clicked, the scrolling function is enabled. This provides a user with the benefits described above.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

Although the present invention has been described with respect to specific preferred embodiments thereof, various changes and modifications may be suggested to one skilled in the art and it is intended that the present invention encompass such changes and modifications as fall within the scope of the appended claims. It is understood that the drawings contained herein are not to scale and that dimensions and quantities of various components can be modified by the designer and still fall within the scope of the present invention.

We claim:

1. A pointing device with a clickable wheel, for controlling an image on a display device, said control of said image including rotational control based on rotational movement of the wheel, comprising:
means for disabling said rotational control when said wheel is clicked and enabling said rotational control when the wheel is unclicked.

2. The pointing device of claim 1, wherein said means for disabling comprises:
at least one slat element mounted coaxially to an axle of the wheel, said slat element including a plurality of slats extending in a direction outward from said axle;
at least one slotted element having a slot situated beneath said axle, said slot being aligned with one of said plurality of slats when the wheel is in an at-rest position;
wherein when the wheel is clicked, one of said plurality of slats engages the slot of said at least one slotted element, thereby preventing rotational movement of the wheel about the axle; and
wherein when the wheel is unclicked, the wheel is biased upward so that none of said plurality of slats engage the slot of said at least one slotted element, thereby allowing rotational movement of the wheel about the axle.

3. A method of controlling the operation of a pointing device having a clickable scroll wheel that performs a scrolling function, comprising:
sensing the clicked/unclicked state of said clickable scroll wheel;
enabling the scrolling function of said clickable scroll wheel when said clickable scroll wheel is an unclicked state; and
disabling the scrolling function of said clickable scroll wheel when said clickable scroll wheel is a clicked state.

4. The method of claim 3, wherein said disabling of the scrolling function is accomplished using a mechanical locking mechanism coupled to said clickable scroll wheel that prevents rotation of said clickable scroll when said clickable scroll wheel is clicked.

5. A pointing device with a clickable wheel, for controlling an image on a display device, comprising:
at least one slat element mounted coaxially to an axle of the wheel, said slat element including a plurality of slats extending in a direction outward from said axle;
at least one slotted element having a slot situated beneath said axle, said slot being aligned with one of said plurality of slats when the wheel is in an at-rest position;
wherein when the wheel is clicked, one of said plurality of slats engages the slot of said at least one slotted element, thereby preventing rotational movement of the wheel about the axle; and
wherein when the wheel is unclicked, the wheel is biased upward so that none of said plurality of slats engage the slot of said at least one slotted element, thereby allowing rotational movement of the wheel about the axle.
